(19) United States
(12) Patent Application Publication
(10) Pub. No.: US 2012/0200890 A1
(43) Pub. Date: Aug. 9, 2012

(54) IMAGE FORMING APPARATUS

(75) Inventor: Makoto Okumura, Osaka (JP)

(73) Assignee: SHARP KABUSHIKI KAISHA, Osaka (JP)

(21) Appl. No.: 13/367,866

(22) Filed: Feb. 7, 2012

(30) Foreign Application Priority Data
Feb. 8, 2011 (JP) 2011-024760

(51) Int. Cl. G06F 3/12

(52) U.S. Cl. 358/1.15

(57) ABSTRACT

The image forming apparatus sends its own operation history information and trouble information occurred to a management server. In a trouble cause analysis system of the management server, related information is extracted from the trouble information, and a trouble cause is analyzed with use of the operation history information of the image forming apparatus. Then, information on a coping method for coping with a trouble is sent to the image forming apparatus. On the image forming apparatus, the sent information on the coping method is displayed, and test printing is performed according to user's selection. In the case of having a good result of the test printing, a user performs operation for determining the coping method so as to change to a device setting corresponding to the determined coping method.

### CROSS-NOTING PARAGRAPH

This non-provisional application claims priority under 35 U.S.C. §119(a) on Patent Application No. 2011-024760 filed in JAPAN on Feb. 8, 2011, the entire contents of which are hereby incorporated herein by reference.

### FIELD OF THE INVENTION

The present invention relates to an image forming apparatus, and more particularly to an image forming apparatus which is configured to be able to extract and present a coping method for a trouble which occurs in the image forming apparatus.

### BACKGROUND OF THE INVENTION

As image forming apparatuses become complex and networked recently, an image forming apparatus constituted as a multifunction peripheral or the like is connected to a communication line such as a telephone line and an Internet line, in which so-called remote maintenance is executed for performing maintenance of the image forming apparatus by a remote management server or the like.

In such remote maintenance, the image forming apparatus sends its own operation situation to a management server through a communication line. The management server instructs to change/adjust an image forming condition so as to obtain an optimal image according to the operation situation that is sent from the image forming apparatus. For example, a change is made for a charging condition, a condition on developing bias and the like according to the operation situation of the image forming apparatus.

Further, a technique has been known that a management server detects, in a case where a trouble occurs in the image forming apparatus, information thereof to prompt component replacement of the image forming apparatus or send service information to the image forming apparatus.

For example, Japanese Laid-Open Patent Publication No. 2003-241955 discloses a system for the purpose of effectively performing management of claims concerning consumables from a user terminal, then promptly and adequately specifying spots having defects and providing measures thereof. Here, on the side of a management device for managing claims concerning consumables that are equipped for an information processing device used by a user, details of the claims are analyzed/classified, and in the case of judging that defects occur in a production lot, information as a result of the analysis (consumables replacement information) is distributed to the user via the Internet, so that details of the distributed information is informed through a display device such as an operation panel.

Additionally, Japanese Laid-Open Patent Publication No. 2010-152250 discloses an image forming apparatus for the purpose of improving leakage and delay of information transmission concerning a countermeasure component against malfunction. The image forming apparatus detects malfunction from loading to discharging of a recording medium, and stores an identification code indicating the detected malfunction. Then, in the event of malfunction, in the case of having the countermeasure component for the stored identification code, a message is displayed for prompting replacement to the coping components.

In the case of performing remote maintenance by a management server that is connected to an image forming apparatus as described above, the management server has judged a status of the image forming apparatus based on a standard condition that is derived from a plurality of parameters of a use history of a component of a photoreceptor drum and the like, a plurality of bias conditions of the image forming apparatus, and the like. In this case, the standard condition is not necessarily what all the users desire, and for example, there also occurs a case where readjustment is performed by a service person in response to a request from the user after performing the remote maintenance based on the standard condition.

Moreover, there is only one piece of service information that is sent from the management server, and only such information is not surely effective for all troubleshooting, so that knowledge and experience of the service person have been essential for troubleshooting.

Additionally, a technique in the above-described Japanese Laid-Open Patent Publication No. 2003-241955 is assumed for management of claims for an image forming apparatus in which defects occur, which management is intended only for defects of consumables, and is not intended for performing analysis based on an operation history of an image forming apparatus body such as a multifunction peripheral. Therefore, it is impossible to present an adequate coping method in the event of a trouble in the image forming apparatus. Moreover, the technique in Japanese Laid-Open Patent Publication No. 2003-241955 is not assumed for attempting a plurality of coping methods against a trouble in the image forming apparatus, in which it is impossible to select by a user any coping method from among a plurality of coping methods.

Further, a technique disclosed in Japanese Laid-Open Patent Publication No. 2010-152250 is intended for detecting malfunction of an image forming apparatus, and not assumed for analysis based on time-series information such as an operation history of the image forming apparatus. Thus, it is impossible to get a situation in the event of a trouble, which makes it impossible to present an adequate coping method. Further, since component replacement is only presented as a coping method, it is impossible to select another coping method such as a setting change of the image forming apparatus.

### SUMMARY OF THE INVENTION

An object of the present invention is to provide an image forming apparatus for analyzing a trouble which occurs in the image forming apparatus so as to be able to present and execute an adequate coping method along a user's intention.

An object of the present invention is to provide an image forming apparatus including an image forming portion for performing image formation in a recording medium based on image data, comprising: a storage portion for storing its own operation history information; a sending portion for sending, in the event of a predetermined trouble, trouble information indicating the trouble occurred to a predetermined management server together with the operation history information; a receiving portion for receiving information on a coping method for the trouble from the management server; a display portion for displaying all the selectable coping methods with use of the received information on the coping method; and an operation input portion for accepting selection operation of the coping method displayed on the display portion, wherein an image forming condition of the image forming portion is set corresponding to the selected coping method.

Another object of the present invention is to provide the image forming apparatus, wherein when a particular coping method is selected from among the coping methods displayed on the display portion, the image forming portion performs test image formation on the image forming condition corresponding to the selected coping method, and sets the image forming condition corresponding to the selected coping method in the image formation portion according to operation input for admitting a result of the test image formation.

Another object of the present invention is to provide the image forming apparatus, wherein the image forming portion performs the test image formation on the image forming condition corresponding to all the coping methods displayed on the display portion, and sets the image forming condition corresponding to the selected coping method in the image formation portion when a particular coping method is selected from among all the coping methods.

Another object of the present invention is to provide the image forming apparatus, wherein the operation history information is sent to the management server via a predetermined communication terminal device.

Another object of the present invention is to provide the image forming apparatus, wherein the information on the coping method with the image forming condition that is set in the image forming portion according to selection of the coping method is sent to the management server.

### BRIEF DESCRIPTION OF THE DRAWINGS

FIG. 1 is a diagram describing an outline of an embodiment of an image forming system to which an image forming apparatus according to the present invention is applied;

FIG. 2 is a diagram for further describing a method of sending operation history information and analysis processing of a management server in the image forming system configuration in FIG. 1;

FIG. 3 is a block diagram for describing a configuration example of the image forming system to which the image forming apparatus according to the present invention is applied;

FIG. 4 is a flowchart for describing a processing example in the image forming system to which the image forming apparatus according to the present invention is applied;

FIG. 5 is a diagram showing a display example of a coping method of a trouble at a display portion of the image forming apparatus; and

FIG. 6 is a diagram showing an example of a display screen for performing selection operation of the coping method in the image forming apparatus.

### PREFERRED EMBODIMENTS OF THE INVENTION

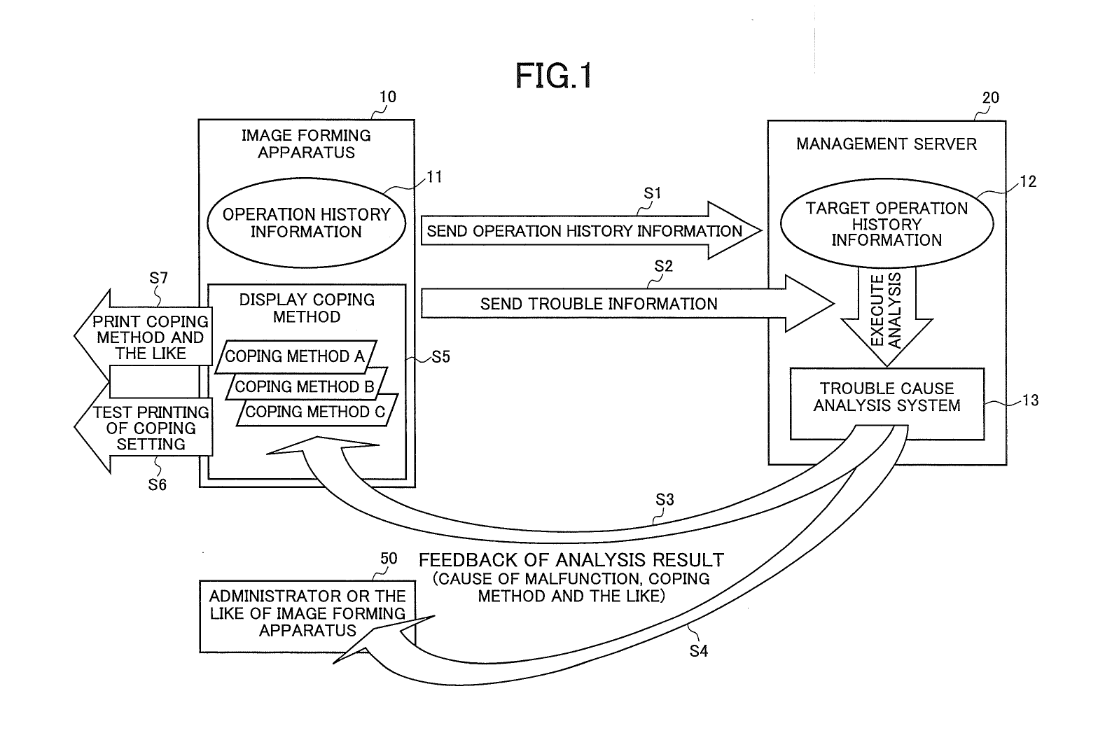

FIG. 1 is a diagram for describing an outline of an embodiment of an image forming system to which an image forming apparatus according to the present invention is applied. The image forming system is comprised of an image forming apparatus 10 having an image forming function and a management server 20 connecting to the image forming apparatus 10 via a communication line. The management server 20 monitors a status of the image forming apparatus 10 via the communication line such as a telephone line and the Internet, and deals with a trouble and the like to perform presentation or the like of a coping method thereof. The image forming apparatus 10 may be a printer alone, a copier alone or the like, and also may apply a multifunction peripheral (MFP) including a copy function, a scanner function, a printer function, a facsimile function, a document save function and the like.

Further, the image forming apparatus 10 and the management server 20 may be integrally configured. For example, the image forming apparatus 10 constituted as a multifunction peripheral or the like may have a configuration in which a function of the management server 20 is contained. In this case, a signal line inside the image forming apparatus is applied to the communication line for connecting the image forming apparatus 10 to the management server 20.

The image forming apparatus 10 stores its own operation history information 11. Its own operation history information is information indicating histories of all the operating states from power-on to power-off in the image forming apparatus 10, and a changing state of various sensors provided with the image forming apparatus 10. For example, the operation history information includes information of job printing and a document reading situation, and information in which an output situation of various sensors, a communication situation with an external device and the like are stored with time information.

The operation history information 11 that is stored in the image forming apparatus 10 is periodically sent to the management server 20 via the communication line (S1). The management server 20 saves the received operation history information in a database together with past operation history information.

Further, in the event of a trouble during operation of the image forming apparatus 10 which causes the image forming apparatus 10 to stop operation according to judgment that there is an abnormality in the apparatus, the image forming apparatus sends trouble information indicating the abnormality occurred and latest operation history information to the management server (S1, S2). The trouble information may be automatically sent when the image forming apparatus 10 detects a trouble in this manner, or may be sent as appropriate by means of operation of the image forming apparatus 10 by a user, a service person or the like.

When the trouble information and the operation history information are sent from the image forming apparatus 10, a trouble cause analysis system 13 of the management server 20 extracts related information from the trouble information, and analyzes a trouble cause using operation history information 12 of the target image forming apparatus 10. As the operation history information 12, information that has been saved in a database or latest operation history information that is sent from the image forming apparatus 10 is able to be used. Additionally, in the case of analysis of a trouble cause, it is possible to use information of a trouble which occurred in another image forming apparatus and coping information thereof.

Subsequently, in the above-described analysis processing, based on the trouble information, the operation history information and the like, information on a coping method for coping with a trouble which actually occurred in the image forming apparatus 10 is extracted from a database of information on a predetermined coping method of troubles to be sent to the image forming apparatus 10. Thereby, feedback of an analysis result is performed (S3).

The information on a coping method may include a cause of malfunction, a coping method thereof and the like of the image forming apparatus 10. The coping method includes, for example, replacement of components of the image forming apparatus 10, a setting change such as a bias change in the image forming apparatus 10 and a setting instruction of a network system. Alternatively, an instruction on a coping method by means of direct operation of the image forming apparatus 10 by a user or a service person, and an instruction to notify an administrator or the like of a trouble situation and the like are also included.

Then, in a case where information on a plurality of coping methods is able to be extracted, the information on the plurality of coping methods is sent to the image forming apparatus 10. Further, the information on the coping method is able to be sent to a predetermined information processing device (PC or the like) which is set in advance by an administrator or the like 50 of the image forming apparatus 10 (S4).

In the image forming apparatus 10, information on the coping method that is sent from the management server 20 is displayed (S5). In this example, it is assumed that three coping methods of A, B and C are extracted as the coping method for coping with a trouble which occurred in the image forming apparatus 10, and these three coping methods are displayed on a display screen. In the case of performing operation for selecting any of the displayed coping methods by a user or the like, in the image forming apparatus 10, test printing (image formation) is performed with a temporary setting corresponding to the selected coping method (S6). In another example, the test printing is performed for all the coping methods sent (coping methods A to C in this example).

In the case of having a good result of the test printing by means of the selected coping method, a user or the like performs operation for determining the coping method so as to change to a device setting corresponding to the determined coping method. In the case of not having a good result of the test printing, it is possible to select another coping method for performing the test printing.

Further, in another example, a user or the like performs operation for selecting a particular coping method from among results of the test printing by means of all the coping methods, thereby changing to a device setting corresponding to the selected coping method.

Information on a coping method that is finally used is sent from the image forming apparatus 10 to the management server 20 again to be accumulated in a database of the management server 20. In the management server 20, the accumulated information is utilized in the event of a next trouble or in the event of a trouble in another image forming apparatus.

Additionally, information on the coping method that is extracted in the management server 20 and displayed in the image forming apparatus 10 is able to be left on the side of the image forming apparatus 10 by printout (S7). A trouble cause, a coping method and the like that are included in the information on the coping method are printed so that an administrator or the like of the image forming apparatus 10 is able to accurately get a current situation, while it is possible to leave the coping method as an evidence.

As described above, the operation history information 11 that is stored in the image forming apparatus 10 is sent as appropriate to the management server 20 periodically or in the event of a trouble in the image forming apparatus 10, or corresponding to user operation for the image forming apparatus 10. At the time, it is possible to send the operation history information 11 directly to the management server 20 from the image forming apparatus 10 via a communication line. Further, the operation history information 11 may be, for example, once sent to a terminal such as a mobile PC which is carried by a service person who performs maintenance of the image forming apparatus 10 (terminal for a service person) for transferring the operation history information 11 to the management server 20 from the terminal for the service person. In this manner, a transmission route of the operation history information 11 is not limited to a route for directly sending from the image forming apparatus 10 to the management server 20, thereby making it possible to perform trouble analysis processing even in the case of network abnormality of the image forming apparatus 10 or the case of having no network environment.

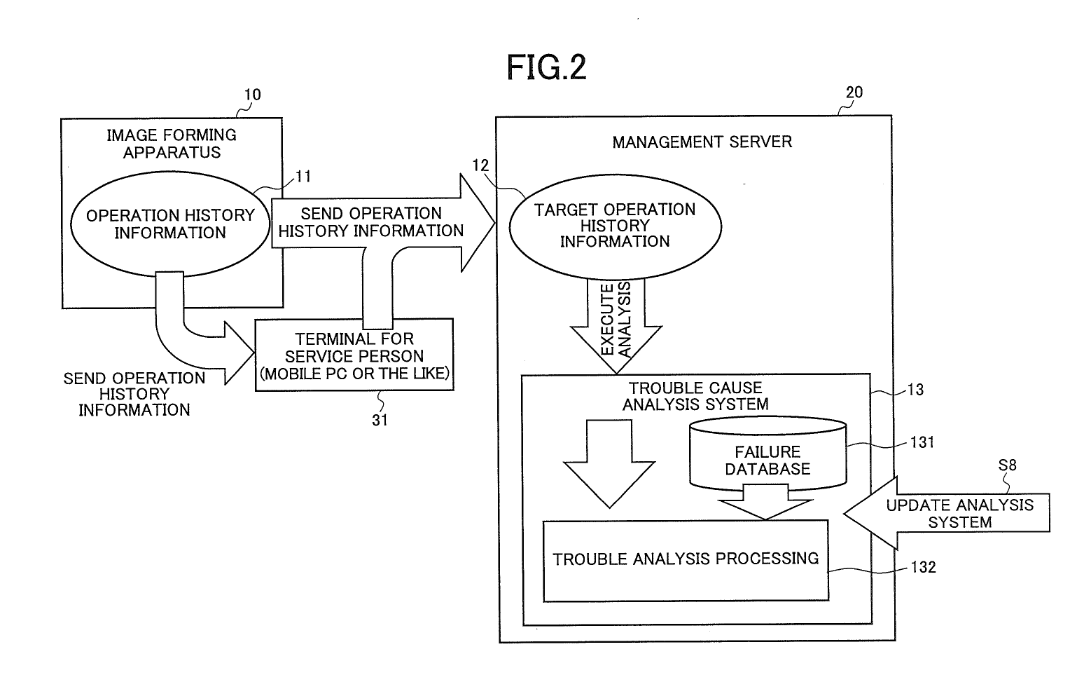

FIG. 2 is a diagram for further describing a method of sending operation history information and analysis processing of a management server in the image forming system configuration in FIG. 1.

The trouble cause analysis system 13 of the management server 20 is comprised of a failure database (storage means) 131 for storing information of failures that occur in the image forming apparatus 10, software that executes trouble analysis from information of the failure database 131, trouble information of the image forming apparatus 10 and the operation history information 11 of the image forming apparatus 10, and hardware such as a CPU and a memory for executing functions of the software. The software that executes the trouble analysis is executed, thereby executing trouble analysis processing 132 with use of the trouble information and the operation history information of the image forming apparatus 10. It is possible to update as appropriate the software that executes the trouble analysis and the failure database 131 (S8), so that it is possible to execute the trouble analysis processing with latest information and software.

With the configuration as described above, the management server 20 analyzes a trouble that occurred in the image forming apparatus 10 with use of the operation history information 11 of the image forming apparatus 10, and a situation in the event of a trouble is thus easily figured out, so that it is possible to present information on a more accurate coping method. Here, it is possible to present information on a plurality of coping methods for the image forming apparatus 10 from the management server 20 and test image formation (printing) is allowed corresponding to the coping method, thus making it possible to cope with a trouble along a user's intention.

Additionally, with the above-described system, the trouble analysis of the image forming apparatus 10 is performed in the management server 20 so that it is possible to perform the trouble analysis without depending on the image forming apparatus 10. Therefore, the software and the data for the trouble analysis are updated in the management server 20, thereby making it possible to perform the trouble analysis by means of a new analysis method all the time, so that it is possible to present a most suitable coping method at the time. Moreover, the management server 20 is allowed to be responsible for a load of the trouble analysis, and an image formation operation of the image forming apparatus 10 is not hampered by the trouble analysis processing.

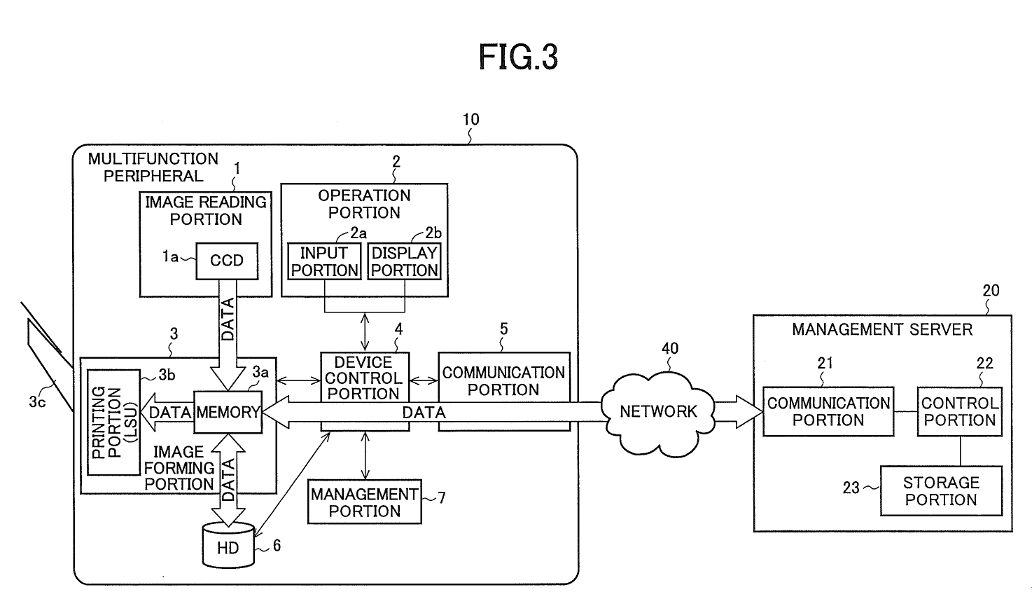

FIG. 3 is a block diagram for describing a configuration example of the image forming system to which the image forming apparatus according to the present invention is applied. The image forming system in the example is comprised of the image forming apparatus 10 that is constituted as a multifunction peripheral (MFP) and the management server 20.

The image forming apparatus 10 is connected to the management server 20 via a network 40. To the network 40, a network such as a public line network including a telephone line or a LAN is able to be applied as appropriate. A plurality of the image forming apparatuses 10 as a target for service offering by the management server 20 are typically connected on the network 40, and states of the image forming apparatuses 10 are managed by the management server 20.

The image forming apparatus 10 is provided with a device control portion 4 that is comprised of a CPU for calculation, a RAM for storing temporary information associated with the calculation, and the like. The device control portion 4 includes a ROM for storing a control program for controlling the image forming apparatus 10. Further, the device control portion 4 is connected to a management portion 7 that is a memory (storage portion) for storing management information (various control information) in order to manage processing that is performed by the image forming apparatus 10. Additionally, the device control portion 4 is connected to an image reading portion 1 for reading an image that is recorded in a recording sheet to generate image data. The image reading portion 1 is provided with a CCD 1a for capturing a document image as image data. Moreover, the device control portion 4 is connected to an operation portion 2 comprised of an input portion (operation input portion) 2a including a touch panel or the like to which information of an instruction from a user and the like is input, and a display portion 2b such as a display panel displaying information necessary for operation, details of a setting change and the like.

Furthermore, the device control portion 4 is connected to an image forming portion 3 for forming an image of image data on a recording medium such as a recording sheet. The image forming portion 3 is provided with a memory 3a for temporally storing image data, a printing portion (LSU) 3b for forming an image from image data that is stored in the memory 3a to be recorded on a recording sheet and a paper feeding tray 3c for containing recording sheets for forming an image in the printing portion 3b. Then, the image forming apparatus 10 is able to form an image in the printing portion 3b after temporarily storing image data generated by the image reading portion 1 in the memory 3a. The image data that is temporarily stored in the memory 3a may be stored in a hard disc (HD) 6.

A communication portion 5 is connected to the network 40 to function as a sending portion and a receiving portion for sending/receiving information to/from the network 40. The communication portion 5 exchanges trouble information and operation history information, or information on a coping method with the management server 20 that is connected to the network 40.

Further, the image forming apparatus 10 receives at the communication portion 5 image data sent from an information processing device such as a not-shown external PC (personal computer) or the like, and is able to form an image from the received image data at the image forming portion 3. In this manner, the image forming apparatus 10 is able to function as a network printer.

As described above, in the image forming apparatus 10, its own operation history information is obtained by the device control portion 4 to be stored and kept in the management portion 7. The operation history information is information and the like indicating histories of all the operating states from power-on to power-off of the image forming apparatus 10, and a changing state of various sensors provided in the image forming apparatus 10 as described above. The operation history information that is stored in the management portion 7 is sent to the management server 20 as appropriate by control of the device control portion 4. Timing for sending the operation history information is predetermined periodical timing, the time when the device control portion 4 detects that a trouble occurs in the image forming apparatus 10, the time when there is operation input for instructing to send the operation history information to the operation portion 2, or the like.

Additionally, the device control portion 4 generates, in the case of detecting that a trouble occurs in the image forming apparatus 10, trouble information corresponding to a trouble thereof for sending to the management server 20. The trouble information is information indicating a state of the trouble occurred, and information which is able to be analyzed by the management server 20. In the case of sending the trouble information, the device control portion 4 obtains latest operation history information from the management portion 7 for sending with the trouble information to the management server 20.

The management server 20 is provided with a communication portion 21 for communicating with the image forming apparatus 10 and other communication terminal via the network 40, a control portion 22 for controlling each portion of the management server and a storage portion 23. In the storage portion 23, the operation history information and the trouble information of the image forming apparatus 10 and information on a coping method for a trouble are accumulated. Additionally, the software and the failure database for performing the trouble analysis in the trouble cause analysis system are stored.

The control portion 22 of the management server performs the trouble cause analysis with use of the software that is stored in the storage portion 23, and extracts information on the coping method for sending to the image forming apparatus 10. The control portion 22 functions as an extracting portion of the coping method in the present invention.

The device control portion 4 of the image forming apparatus 10 extracts information necessary for display from the information on the coping method so as to be displayed on the display portion 2b. Further, the device control portion 4 performs a temporary device setting corresponding to the coping method that is sent from the management server 20 to perform test printing (test image formation) by the image forming portion 3. The test printing is executed based on the coping method that is selected corresponding to operation input for the input portion 2a in an embodiment, and in another embodiment, executed based on all the coping methods that are sent from the management server 20.

The device control portion 4 then decides a final coping method corresponding to the operation input for the input portion 2a, and performs the device setting based on the decided coping method. Further, information on the decided coping information is sent to the management server 20.

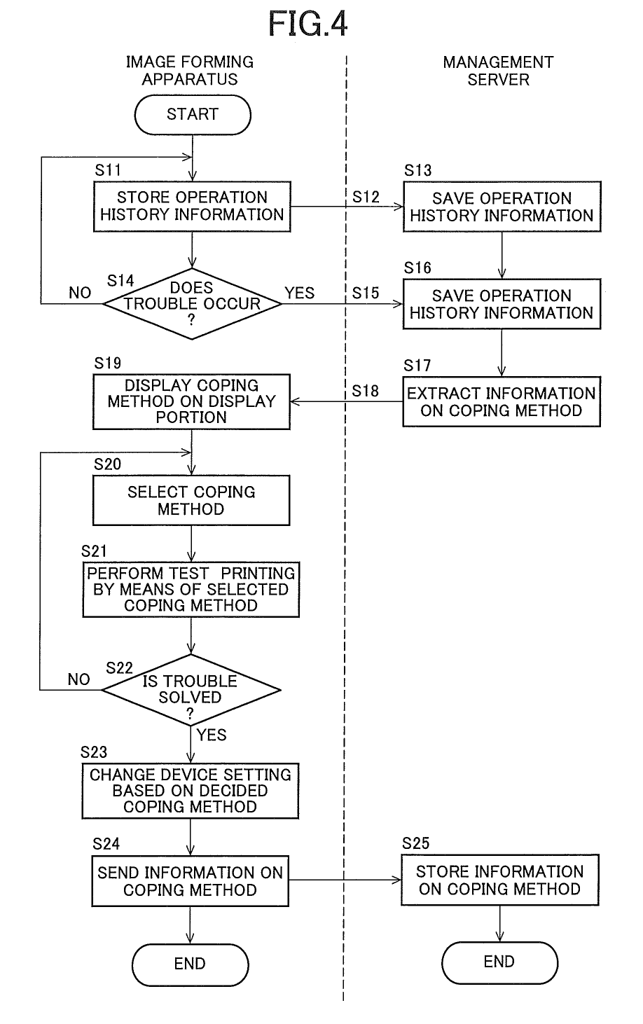

FIG. 4 is a flowchart for describing a processing example in the image forming system to which the image forming apparatus according to the present invention is applied, and intended to show a flow of processing between the image forming apparatus and the management server.

In the image forming apparatus, its own operation history information is stored after power-on (step S11). In the image forming apparatus, a service person checks past operation history information in the event of a trouble so that it is possible to estimate an abnormality cause to perform maintenance.

The operation history information that is stored in the image forming apparatus is sent periodically to the management server that is connected via a communication line (step S12). In the management server, the operation history information which is received from the image forming apparatus is stored with the past operation history information (step S13). Here, the management server may be configured to analyze the received operation history information, and checks whether parameters set for a component life and a device (fixing temperature, developing bias and the like) fall within a predetermined range so as to monitor a state of the image forming apparatus.

In the event of a trouble during operation of the image forming apparatus which causes the image forming apparatus to stop operation according to judgment that there is an abnormality in the apparatus (step S14—Yes), the image forming apparatus sends trouble information indicating the abnormality occurred and latest operation history information to the management server (step S15). The management server saves the sent operation history information (step S16).

Here, the image forming apparatus is able to detect the device abnormality in the event of a trouble to automatically send the trouble information and the operation history information to the management server. Alternatively, in a case where the device abnormality occurred is a “defective image” or the like, a user or a service person presses a “device diagnosis analysis button” so that it is possible to send the trouble information and the latest operation history information of the image forming apparatus to the management server. This makes it possible in the management server to analyze an abnormal state and an operation history of the image forming apparatus by a diagnosis analysis function to detect a setting abnormality and a component life.

The management server that receives the trouble information and the latest operation history information extracts related information from the trouble information, and analyzes an occurrence cause of a trouble to extract information on a coping method (step S17).

As an example, a cause analysis example is shown in the case of a shading trouble. Shading in the image forming apparatus is intended to perform correction processing for removing various distortions which occur in an illumination system, an image formation system, an imaging system and the like for an input image signal.

When the trouble information that is sent from the image forming apparatus indicates the shading trouble, in the management server, necessary related information including

1. a condition of a scanner light source and an energization time

2. a condition of a scanner motor

3. a communication condition of a scanner substrate

4. a memory check state of the scanner substrate (checksum and the like)

and the like is extracted from the operation history information to be used for analysis of a trouble cause.

As another example, when a (photoreceptor) drum lock in the image forming apparatus is detected and the image forming apparatus is abnormally stopped, necessary related information including

1. voltage applied to a drum motor and a driving current

2. a driving current to a developing motor

3. the type of a developing cartridge (recommended item and others)

4. an abnormal signal and a trouble history of a developing device and a transcriber

5. a contact/separation state between a secondary transfer belt and a photoreceptor belt

and the like is extracted from the operation history to be used for analysis of a trouble cause.

Further, in the management server, it is possible to store trouble information that occur in another image forming apparatus and information on a coping method, which are used as a reference to extract information on a coping method for a trouble currently occurring. The extracted information on the coping method is sent to the image forming apparatus through a communication line (step S18).

In the image forming apparatus, in the case of receiving the information on the coping method of a trouble that is sent from the management server, information necessary for display is extracted from the information to display the coping method of a trouble on the display portion (step S19).

A display example of the coping method in the display portion is shown in FIG. 5. On a display screen of the display portion, it is possible to display plural coping method information 101 that is extracted in the management server. As the coping method, a plurality of coping methods are extracted even in the event of the same trouble in some cases, such as a setting change inside the image forming apparatus and component (unit) replacement. Additionally, there is also a case where it is necessary to correspond by a combination of a plurality of coping methods. In the management server, information on a representative coping method is extracted according to trouble information for sending to the image forming apparatus. On the display portion of the image forming apparatus, the sent information on the representative coping method is displayed in a form in which a user or a service person easily understands.

The display portion of the image forming apparatus is comprised of, for example, an LCD (liquid crystal panel) with a touch panel. A user or the like touches information of any coping method from among the coping method information 101 that is displayed on a display screen 100 of the display portion, and is thereby able to select the coping method (step S20). Here, the selected information of the coping method is inverted to be clearly shown to be in a selected state.

Then, when a user or the like touches a test print button 102, test printing is performed in a setting corresponding to the selected coping method (step S21). At the time, even in a case where a trouble is caused by a scanner (image reading portion), operation from document reading to printing is performed so that it is possible to perform test printing. Further, there is a case where it is necessary to replace a component or a unit of the developing cartridge or the like depending on the coping method, however, in this case, it is configured that the test printing is not executed until detecting replacement of a target component or unit by a sensor even when the coping method necessary for replacing a component or the like is selected by a user or the like.

In this manner, the test printing is performed according to the coping method selected by a user or the like, and in the case of having a good print result by the test printing, the user or the like judges that a trouble of the image forming apparatus is solved (step S22—Yes), and touches an OK button 103, thereby making it possible to return to a normal screen. On the other hand, when the user or the like judges that the test result by the test printing is not good, the process returns to step S20 (step S22—No), and it is possible to select another coping method from among the coping methods that are displayed on the display portion.

In a case where the test printing is good and the OK button 103 is touched, the image forming apparatus stores a setting value corresponding to the coping method that is selected when the OK button 103 is touched in a nonvolatile memory inside the apparatus, and changes a device setting according to the selected coping method (step S23).

Then, the image forming apparatus sends information on the coping method that solved a trouble to the management server (step S24). The management server stores, in the case of receiving the information on the coping method from the image forming apparatus, the information on the coping method with the trouble information and the operation history information as a set (step S25) for utilizing in the event of a next trouble or in the event of a trouble in another image forming apparatus. In this manner, in the present embodiment, concerning the coping method selected by a user or the like from coping methods extracted by the management server, it is configured that it is possible to confirm a printed result by the test printing in advance so as to be able to select a suitable coping method.

In another embodiment in the image forming system to which the image forming apparatus according to the present invention is applied, it is possible to omit processing at steps S19 and S20 in FIG. 4.

Specifically, in a case where the management server extracts and sends information on the coping method at steps S17 and S18 and the image forming apparatus receives the information on the coping method, in the image forming apparatus, test printing is performed sequentially using all the coping methods without displaying on the display portion the received information on the coping method. For example, in a case where three types of coping methods are extracted in the management server, in the image forming apparatus, three types of test printing are executed in a device setting corresponding to the three types of the coping methods. A user or the like views test printing results of all the coping methods and is able to select an optimal coping method. In this case, in the test printing at step S21, test printing by means of all the coping methods is performed without user's selection, and operation for selecting a particular coping method is performed without pressing an OK button at step S22.

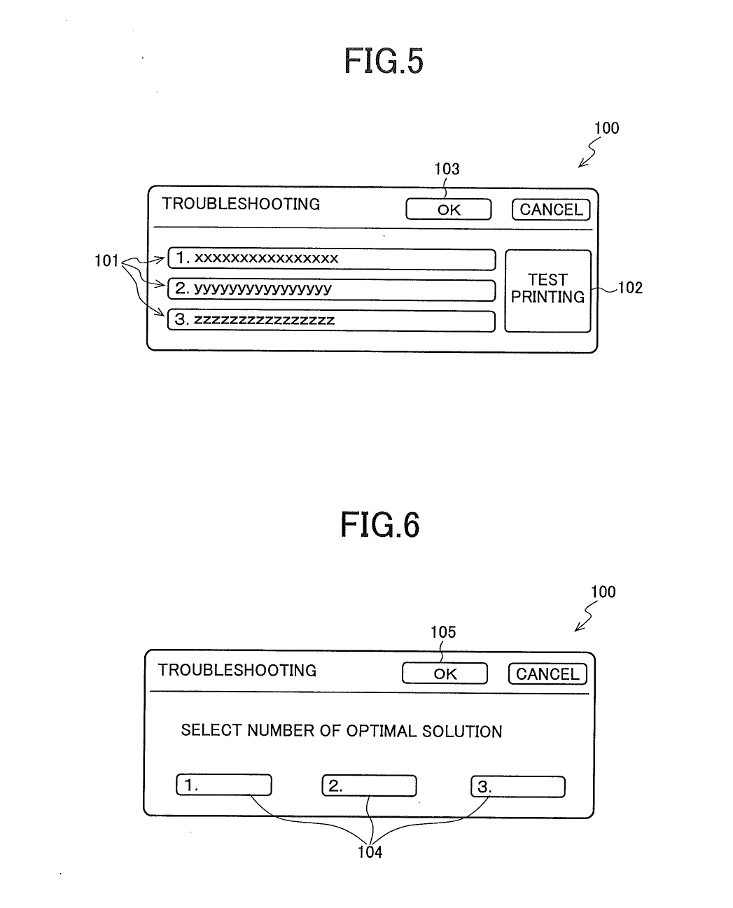

FIG. 6 is a diagram showing an example of a display screen for performing selection operation of the coping method at step S22 in FIG. 4. In the present embodiment, after executing test printing by means of all the coping methods extracted by the management server, all the coping methods 104 are displayed on the display screen 100 of the display portion, and any coping method 104 becomes selectable. When any coping method 104 is selected by user's operation, in the image forming apparatus, a device setting is changed corresponding to the coping method.

In this manner, in the present embodiment, test printing is performed concerning all the coping methods extracted by the management server so that a user or the like is able to select an optimal coping method based on the test printing result.

Next, description will be given for a processing example for performing self-diagnosis in the image forming apparatus corresponding to user's operation for the image forming apparatus. For example, in a case where trouble occurrence does not cause stop of the image forming apparatus but an abnormality such as a defect of a printed image occurs, a user or a service person presses a diagnosis button of the image forming apparatus so that it is possible to analyze its own operation condition in the image forming apparatus.

Analysis examples in the image forming apparatus in this case are shown as follows.

1. The apparatus is checked from counter information, fixing temperature transition, a conveyance speed of a recording sheet and the like whether or not to be normally operated.

2. A trouble spot is specified from a trouble flag inside the apparatus and sensor information.

3. Bias of development/transfer and the like is confirmed.

4. Change histories of version upgrade of firmware and the like are referred.

5. Presence/absence of a tendency of a trouble in a machine itself is checked as compared to a database of an external device whether there is another machine having a trouble in a similar operation history.

In this manner, a self-diagnosis function is activated to perform analysis by pressing the diagnosis button in the image forming apparatus, as a result, for example, adjustment of a print setting such as adjustment of a sheet conveyance speed, adjustment of various bias, adjustment of a fixing temperature and adjustment of laser irradiation, replacement of parts (replacement of a drum, developer replenishment and the like), version upgrade/downgrade of firmware and the like are extracted as coping methods. The extracted coping method is displayed on the display portion as the above-described embodiment so that it is possible to execute test printing corresponding to user's selection or the like. Alternatively, test printing is performed for all the extracted coping methods, and according to the result, a user or the like may select a coping method to be used.

As described above, according to the present invention, it is possible to provide an image forming apparatus for analyzing a trouble which occurs in the image forming apparatus so as to be able to present and execute an adequate coping method along a user's intent.

1. An image forming apparatus including an image forming portion for performing image formation in a recording medium based on image data, comprising:
a storage portion for storing its own operation history information;
a sending portion for sending, in the event of a predetermined trouble, trouble information indicating the trouble occurred to a predetermined management server together with the operation history information;
a receiving portion for receiving information on a coping method for the trouble from the management server;
a display portion for displaying all the selectable coping methods with use of the received information on the coping method; and
an operation input portion for accepting selection operation of the coping method displayed on the display portion, wherein
an image forming condition of the image forming portion is set corresponding to the selected coping method.

2. The image forming apparatus as defined in claim 1, wherein
when a particular coping method is selected from among the coping methods displayed on the display portion, the image forming portion performs test image formation on the image forming condition corresponding to the selected coping method, and sets the image forming condition corresponding to the selected coping method in the image formation portion according to operation input for admitting a result of the test image formation.

3. The image forming apparatus as defined in claim 1, wherein
the image forming portion performs the test image formation on the image forming condition corresponding to all the coping methods displayed on the display portion, and sets the image forming condition corresponding to the selected coping method in the image formation portion when a particular coping method is selected from among all the coping methods.

4. The image forming apparatus as defined in claim 1, wherein
the operation history information is sent to the management server via a predetermined communication terminal device.

5. The image forming apparatus as defined in claim 1, wherein
the information on the coping method with the image forming condition that is set in the image forming portion according to selection of the coping method is sent to the management server.
